(19) United States
(12) Patent Application Publication
(10) Pub. No.: US 2024/0052197 A1
(43) Pub. Date: Feb. 15, 2024

(54) COATING AGENT FOR RESIN GLASS, AND RESIN GLASS

(71) Applicants: KABUSHIKI KAISHA TOYOTA JIDOSHOKKI, Kariya-shi, Aichi (JP); KANSAI PAINT CO., LTD., Amagasaki-shi, Hyogo (JP)

(72) Inventors: Hidenori MUNEKATA, Aichi (JP); Motoshige ISOBE, Aichi (JP); Ken NODA, Aichi (JP); Kota GOTO, Kanagawa (JP); Naoko AGARI, Kanagawa (JP)

(73) Assignees: KABUSHIKI KAISHA TOYOTA JIDOSHOKKI, Kariya-shi, Aichi (JP); KANSAI PAINT CO., LTD., Amagasaki-shi, Hyogo (JP)

(21) Appl. No.: 18/266,763

(22) PCT Filed: Sep. 9, 2021
(86) PCT No.: PCT/JP2021/033106

§ 371 Date: Jun. 12, 2023

(30) Foreign Application Priority Data
Jan. 20, 2021 (JP) 2021-006807

(51) Int. Cl. C09D 175/16; C09D 4/00; C09D 7/48; C09D 7/62

(52) U.S. Cl. CPC C09D 175/16; C09D 4/00; C09D 7/48; C09D 7/62; C08K 3/36

(57) ABSTRACT

A coating agent includes a film-forming component containing a component A consisting of a urethane (meth)acrylate having an isocyanuric ring skeleton, a component B consisting of a tri(meth)acrylate having an isocyanuric ring skeleton and having no urethane bond, a component C consisting of a multi-functional (meth)acrylate having a (meth)acrylic equivalent of 80 to 200, and a component D consisting of a urethane (meth)acrylate that has a polycarbonate skeleton, two to four polymerizable unsaturated groups per molecule, and a weight average molecular weight of 10,000 or less, and a component E consisting of a photoradical polymerization initiator. The content of the component E is 0.1 parts by mass or more and 10 parts by mass or less based on 100 parts by mass of the total film-forming component.

### CROSS REFERENCE TO RELATED APPLICATIONS

This application is a National Stage of International Application No. PCT/JP2021/033106 filed on Sep. 9, 2021, claiming priority based on Japanese Patent Application No. 2021-006807 filed on Jan. 20, 2021.

### TECHNICAL FIELD

The present disclosure relates to a coating agent for resin glass, and resin glass.

### BACKGROUND ART

In the past, windows of vehicles such as automobiles or vehicles used for railways include inorganic glass. In recent years, for the purpose of weight reduction of a vehicle, replacement of inorganic glass constituting a window or the like with resin glass including a transparent resin lighter than inorganic glass has been studied. However, resin glass has a problem of low weatherability as compared with inorganic glass.

In order to solve such a problem and improve the weatherability of resin glass, a technology of forming a hard film on the surface of a transparent resin has been proposed. For example, Patent Document 1 describes a method for forming a coated polycarbonate plate-like molded body including a polycarbonate plate-like molded body, a primer layer provided on at least one face of the molded body, and a hard coat layer formed on the primer layer. The hard coat layer is formed by heating and curing a hard coating solution containing colloidal silica and a hydrolytic condensate of trialkoxysilane.

### PRIOR ART LITERATURE

### Patent Documents

Patent Document 1: JP-A-2004-27110

### SUMMARY

The coated polycarbonate plate-like molded body according to Patent Document 1 includes a film having a two-layer structure of a primer layer and a hard coat layer. Formation of such a film, however, requires to sequentially perform a step of applying a primer onto the plate-like molded body, a step of drying the primer to form a primer layer, a step of applying a coating agent onto the primer layer, and a step of curing the coating agent to form a hard coat layer. This leads to a cumbersome work to form a film and an increase of cost required for the work of forming the film.

The present disclosure has been made in view of such a background, and an object of the present disclosure is to provide a coating agent for resin glass that can form a coating film having excellent weatherability by a simple method, and a resin glass produced using the coating agent for resin glass.

One aspect of the present disclosure is a coating agent for resin glass, the coating agent including:
a film-forming component including
   a component A consisting of a urethane (meth)acrylate having an isocyanuric ring skeleton,
   a component B consisting of a tri(meth)acrylate having an isocyanuric ring skeleton and having no urethane bond,
   a component C consisting of a multi-functional (meth)acrylate having a (meth)acrylic equivalent of 80 to 200, and
   a component D consisting of a urethane (meth)acrylate that has
      a polycarbonate skeleton,
      two to four polymerizable unsaturated groups per molecule, and
      a weight average molecular weight of 10,000 or less; and
a component E consisting of a photoradical polymerization initiator,
wherein a content of the component E is 0.1 parts by mass or more and 10 parts by mass or less based on 100 parts by mass of the total film-forming component.

Another aspect of the present disclosure is resin glass comprising:
a substrate including a transparent resin; and
a coating film including a cured product of the coating agent for resin glass according the above-described aspect and covering a surface of the substrate.

The coating agent for resin glass (hereinafter, referred to as a “coating agent”) contains a film-forming component containing the components A to D and a component E including a photoradical polymerization initiator. All of the components A to D have a photoradical polymerizable functional group such as a (meth)acryloyl group. Thus, a coating film can be formed by curing the film-forming component by a simple method in which the coating agent is applied onto a substrate and then the coating agent is irradiated with light to generate radicals from the component E.

The coating film formed by curing the coating agent has a network structure in which components are three-dimensionally crosslinked, and a structure derived from the component D is incorporated in the network structure. The component D can relieve stress in the coating film. The coating film in which the structure derived from the component D is incorporated can maintain the toughness of the coating film over a long period of time, and can avoid occurrence of a crack even when the coating film is degraded by, for example, use over a long period of time. Accordingly, the coating film has excellent weatherability.

Therefore, according to the above aspect, a coating agent for resin glass that can form a coating film having excellent weatherability by a simple method can be provided.

### DETAILED DESCRIPTION

(Coating Agent for Resin Glass)

The film-forming component in the coating agent includes components A to D. By curing the coating agent containing these components, a coating film having excellent weatherability can be formed. The coating film formed by curing the coating agent is also excellent in toughness, adhesion to the substrate, and abrasion resistance. Hereinafter, each component contained in the coating agent will be explained.

Component A: Urethane (Meth)Acrylate Having Isocyanuric Ring Skeleton

The coating agent contains, as an essential component, the component A including a urethane (meth)acrylate having an isocyanuric ring skeleton. By blending the component A in the coating agent, the weatherability of the coating film formed by curing the coating agent can be improved.

The content of the component A in the coating agent is preferably set to be 3 parts by mass or more and 60 parts by mass or less based on 100 parts by mass of the film-forming component. In this case, while the effect of improving the weatherability by the component A is secured, the content of components other than the component A can be sufficiently increased, and the action and effect by these components can be enhanced in a well-balanced manner. As a result, weatherability, toughness, adhesion to the substrate, and abrasion resistance can be improved in a well-balanced manner. From the viewpoint of further enhancing such an action and effect, the content of the component A in the coating agent is, based on 100 parts by mass of the film-forming component, more preferably set to be 5 parts by mass or more and 50 parts by mass or less, still more preferably 10 parts by mass or more and 45 parts by mass or less, and particularly preferably 15 parts by mass or more and 40 parts by mass or less.

As the component A, for example, a compound represented by the following general formula (1) can be adopted. The compound represented by general formula (1) can be synthesized by, for example, an addition reaction between a nurate trimer of hexamethylene diisocyanate and hydroxyalkyl (meth)acrylate or an ε-caprolactone-modified product thereof. As the component A, one kind of compound selected from these compounds may be used, or two or more kinds of compounds selected therefrom may be used in combination.

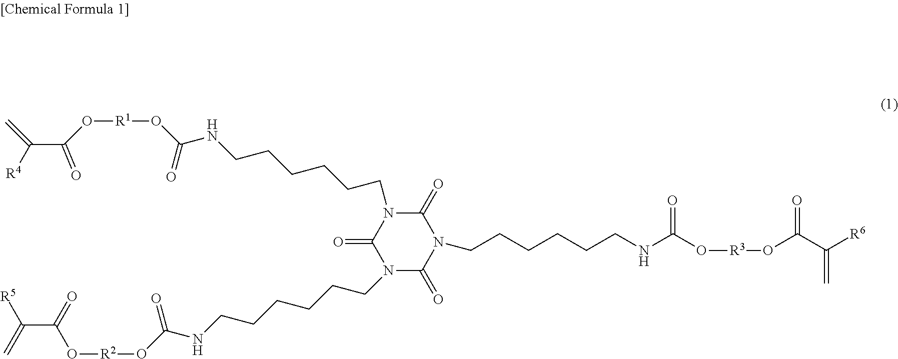

Note that R¹, R², and R³ in the general formula (1) are divalent organic groups each having 2 to 10 carbon atoms. R¹, R², and R³ may be the same organic group, or organic groups different from each other. When an ε-caprolactone-modified product of a hydroxyalkyl (meth)acrylate is added to a nurate trimer of hexamethylene diisocyanate, any partial structure of —COCH₂CH₂CH₂CH₂CH₂— or —OCOCH₂CH₂CH₂CH₂CH₂— is included in the above-described divalent organic group.

R¹, R², and R³ are each preferably an alkylene group having 2 to 4 carbon atoms, such as an ethylene group, a trimethylene group, a propylene group, or a tetramethylene group, and more preferably a tetramethylene group. In this case, the abrasion resistance and weatherability of the coating film can be further improved.

R⁴, R⁵, and R⁶ in the general formula (1) are each a hydrogen atom or a methyl group. R⁴, R⁵, and R⁶ may be the same or different from each other. R⁴, R⁵, and R⁶ are each preferably a hydrogen atom. In this case, the curability of the coating agent can be further improved.

The addition reaction between a nurate trimer of hexamethylene diisocyanate and hydroxyalkyl (meth)acrylate or an ε-caprolactone-modified product thereof may be performed without using a catalyst, or may be performed using a catalyst in order to facilitate the reaction. As the catalyst, for example, a tin-based catalyst such as dibutyltin dilaurate or an amine-based catalyst such as triethylamine can be used.

Component B: Tri(Meth)Acrylate Having Isocyanuric Ring Skeleton and Having No Urethane Bond

The coating agent contains, as an essential component, the component B including a tri(meth)acrylate having an isocyanuric ring skeleton and having no urethane bond. By blending the component B in the coating agent, the weatherability of the cured coating film can be improved, as well as adhesion between the coating film and the substrate can be improved.

The content of the component B in the coating agent is preferably set to be 10 parts by mass or more and 50 parts by mass or less based on 100 parts by mass of the film-forming component. In this case, while the effect of improving weatherability and adhesion by the component B is secured, the content of components other than the component B can be sufficiently increased, and the action and effect by these components can be enhanced in a well-balanced manner. As a result, weatherability, toughness, adhesion to the substrate, and abrasion resistance can be improved in a well-balanced manner.

From the viewpoint of further enhancing such an action and effect, the content of the component B in the coating agent is, based on 100 parts by mass of the film-forming component, more preferably set to be 15 parts by mass or more and 50 parts by mass or less, still more preferably 15 parts by mass or more and 45 parts by mass or less, and particularly preferably 20 parts by mass or more and 45 parts by mass or less.

As the component B, for example, a compound represented by the following general formula (2) can be employed. The compound represented by general formula (2) can be synthesized by, for example, a condensation reaction between an alkylene oxide adduct of isocyanuric acid and (meth)acrylic acid or an ε-caprolactone-modified product thereof. As the component B, one kind of compound selected from these compounds may be used, or two or more kinds of compounds selected therefrom may be used in combination.

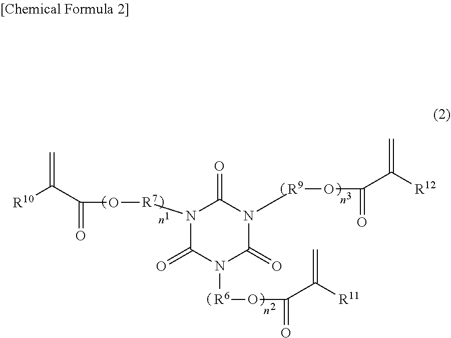

Note that R⁷, R⁸, and R⁹ in the general formula (2) are divalent organic groups each having 2 to 10 carbon atoms. In addition, n¹ is 1 to 3, n² is 1 to 3, n³ is 1 to 3, and the sum of n¹, n², and n³ is 3 to 9. The value of the sum of n¹, n², and n³ represents the average number of moles of the alkylene oxide added per molecule of the compound represented by the general formula (2).

R⁷, R⁸, and R⁹ in the general formula (2) may be the same organic group, or organic groups different from each other. In addition, n¹, n², and n³ may be the same value, or values different from each other. When an ε-caprolactone-modified product of meth(acrylic) acid is condensed with isocyanuric acid, any partial structure of COCH₂CH₂CH₂CH₂CH₂— or —OCOCH₂CH₂CH₂CH₂CH₂— is included in the above-described divalent organic group.

R⁷, R⁸, and R⁹ in the general formula (2) are each preferably an alkylene group having 2 to 4 carbon atoms, such as an ethylene group, a trimethylene group, a propylene group, or a tetramethylene group, and more preferably an ethylene group. In this case, the abrasion resistance and weatherability of the coating film can be further improved.

The value of n¹, the value of n², and the value of n³ in the general formula (2) are each preferably 1. In this case, the adhesion of the coating film to the substrate can be further improved.

R¹⁰, R¹¹, and R¹² in the general formula (2) are each a hydrogen atom or a methyl group. R¹⁰, R¹¹, and R¹² may be the same or different from each other. R¹⁰, R¹¹, and R¹² are each preferably a hydrogen atom. In this case, the curability of the coating agent can be further improved.

Component C: Multi-Functional (Meth)Acrylate Having (Meth)Acrylic Equivalent of 80 to 200

The coating agent contains, as an essential component, the component C including a multi-functional (meth)acrylate having a (meth)acrylic equivalent of 80 to 200. The component C has a plurality of (meth)acryloyl groups in one molecule. Due to polymerization of the (meth)acryloyl group of the component C with the (meth)acryloyl group contained in the component A or the like, two or more molecules of a component having (meth)acryloyl group can be bonded to one molecule of the component C. Therefore, by curing the coating agent containing the component C, the network structure in the coating film can be made denser, and the abrasion resistance of the resin glass can be further improved.

The content of the component C in the coating agent is preferably set to be 5 parts by mass or more and 50 parts by mass or less based on 100 parts by mass of the total film-forming component. By setting the content of the component C to 5 parts by mass or more and 50 parts by mass or less, while the effect of improving abrasion resistance by the component C is secured, the content of components other than the component C can be sufficiently increased, and the action and effect by these components can be enhanced in a well-balanced manner. As a result, weatherability, toughness, adhesion to the substrate, and abrasion resistance can be improved in a well-balanced manner.

From the viewpoint of further enhancing such an action and effect, the content of the component C is, based on 100 parts by mass of the total film-forming component, more preferably set to be 5 parts by mass or more and 45 parts by mass or less, still more preferably 10 parts by mass or more and 40 parts by mass or less, and particularly preferably 15 parts by mass or more and 35 parts by mass or less.

As the component C, a compound having three or more (meth)acryloyl groups per molecule and having a (meth)acrylic equivalent, that is, a molecular weight per (meth)acryloyl group of 80 to 200 can be used. As the component C, one kind of compound selected from these compounds may be used, or two or more kinds of compounds selected therefrom may be used in combination.

When the (meth)acrylic equivalent of the component C is less than 80, the number of (meth)acryloyl groups per molecule is excessively increased, so that the amount of unreacted (meth)acryloyl groups contained in the cured coating film tends to be increased. As a result, after the coating film is formed, an unintended crosslinking reaction may proceed in the coating film, and a crack may be likely to occur.

When the (meth)acrylic equivalent of the component C exceeds 200, the number of (meth)acryloyl groups per molecule is decreased, so that the number of crosslinking points included in the cured coating film tends to be insufficient.

Component D: Urethane (Meth)Acrylate Having Polycarbonate Skeleton and Two to Four Polymerizable Unsaturated Groups Per Molecule and Having a Weight Average Molecular Weight of 10,000 or Less

The coating agent contains, as an essential component, the component D including urethane (meth)acrylate having a polycarbonate skeleton and two to four polymerizable unsaturated groups per molecule and having a weight average molecular weight of 10,000 or less. By blending the component D in the coating agent, the toughness of the coating film after cured can be improved. Improvement in the toughness of the coating film can reduce the occurrence of a crack even when the coating film is degraded by, for example, use over a long period of time.

The content of the component D in the coating agent is preferably set to be 1 part by mass or more and 30 parts by mass or less based on 100 parts by mass of the film-forming component. By setting the content of the component D in the coating agent to 1 part by mass or more, the weatherability of the coating film can be improved, and the occurrence of a crack can be reduced over a long period of time. From the viewpoint of improving the weatherability of the coating film, the content of the component D in the coating agent is, based on 100 parts by mass of the film-forming component, more preferably set to be 2 parts by mass or more, and still more preferably 3 parts by mass or more.

By setting the content of the component D in the coating agent to 30 parts by mass or less, while the effect of improving weatherability by the component D is secured, the content of components other than the component D can be sufficiently increased, and the action and effect by these components can be enhanced in a well-balanced manner. As a result, weatherability, toughness, adhesion to the substrate, and abrasion resistance can be improved in a well-balanced manner.

From the viewpoint of further enhancing such an action and effect, the content of the component D is, based on 100 parts by mass of the total film-forming component, more preferably set to be 20 parts by mass or less, still more preferably 15 parts by mass or less, and particularly preferably 10 parts by mass or less.

The component D has a polycarbonate skeleton. This makes it possible to improve the hardness of the coating film.

The number of polymerizable unsaturated groups contained in the component D is two to four per molecule. This makes it possible to improve the toughness of the coating film and reduce the occurrence of a crack. From the viewpoint of further improving the toughness of the coating film and the effect of reducing occurrence of a crack, the number of polymerizable unsaturated groups contained in the component D is preferably two to three per molecule, and more preferably two per molecule.

Examples of the polymerizable unsaturated group contained in the component D include a (meth)acryloyl group, a vinyl group, a propenyl group, a butadienyl group, a styryl group, an ethynyl group, a cinnamoyl group, a maleate group, and an acrylamide group. From the viewpoint of curability, the polymerizable unsaturated group contained in the component D is preferably a (meth)acryloyl group, and more preferably an acryloyl group.

The weight average molecular weight of the component D is 10,000 or less. By setting the weight average molecular weight of the component D to 10,000 or less, the toughness and weatherability of the coating film can be improved. From the viewpoint of further improving the toughness and weatherability of the coating film, the weight average molecular weight of the component D is preferably set to be 8,500 or less, and more preferably 7,000 or less.

The weight average molecular weight of the component D is preferably 3,000 or more, and more preferably 4,000 or more. In this case, adhesion to the substrate and abrasion resistance can be improved in a well-balanced manner while toughness and weatherability of the coating film are secured.

The weight average molecular weight of the component D is a value of a weight average molecular weight in terms of polystyrene obtained by gel permeation chromatography (GPC). The measurement conditions of GPC are specified as follows.
Apparatus: HPLC-8220 (manufactured by Tosoh Corporation)
Column configuration: TSKgel SuperHZ3000+TSKgel SuperHZ1000 (both manufactured by Tosoh Corporation)
Detector: Refractive index detector
Eluent: Tetrahydrofuran
Flow rate of eluent: 0.6 mL/min
Temperature: 40° C.
Calibration: In terms of polystyrene
Sample concentration: 0.01 g/5 mL

The component D can be manufactured by, for example, reacting a polycarbonate diol, a diisocyanate compound, and a hydroxy group-containing (meth)acrylic acid ester. Examples of a commercially available product that can be used as the component D include “UV-3310B” manufactured by The Nippon Synthetic Chemical Industry Co., Ltd., and “UN-9000PEP” manufactured by Negami Chemical Industrial Co., Ltd., and the like.

Component E: Photoradical Polymerization Initiator

The coating agent contains, as an essential component, the component E including a photoradical polymerization initiator. The component E can generate radicals in the coating agent by irradiating the coating agent with light having a specific wavelength determined in accordance with the molecular structure of the component E. This radical can initiate a polymerization reaction between photoradical polymerizable functional groups, such as a (meth)acryloyl group, contained in a film-forming component.

The content of the component E in the coating agent is set to be 0.1 parts by mass or more and 10 parts by mass or less based on 100 parts by mass of the film-forming component. By setting the content of the component E in the coating agent to 0.1 parts by mass or more, the coating agent disposed on the substrate can be cured to form a coating film.

When the content of the component E is set to be less than 0.1 parts by mass, the amount of radicals to be a starting point of the polymerization reaction is insufficient, making it difficult to sufficiently cure the coating agent. As a result, the hardness of the coating film is lowered, and the durability against scratches may be lowered. In this case, problems such as a decrease in adhesion of the coating film to the substrate and a decrease in weatherability may occur.

On the other hand, an excessively large content of the component E may cause deterioration in storage stability of the coating agent. For example, an unintended radical polymerization reaction is likely to be initiated during storage of the coating agent. In this case, an unreacted polymerization initiator tends to remain in the cured coating film. An excessively large amount of the unreacted polymerization initiator remaining in the coating film may promote deterioration of the coating film. Furthermore, material cost may be increased in this case.

By setting the content of the component E to 10 parts by mass or less, the amount of radicals to be a starting point of a polymerization reaction can be sufficiently increased while the above-described problems are avoided, and the coating agent can be sufficiently cured.

As the component E, for example, an acetophenone-based compound, a benzophenone-based compound, an α-ketoester-based compound, a phosphine oxide-based compound, a benzoin compound, a titanocene-based compound, an acetophenone/benzophenone-hybrid-based photo initiator, an oxime ester-based photo polymerization initiator, and camphorquinone can be used.

Examples of the acetophenone-based compound include 2,2-dimethoxy-1,2-diphenylethane-1-one, 1-hydroxycyclohexyl-phenyl-ketone, 2-hydroxy-2-methyl-1-phenylpropane-1-one, 1-[4-(2-hydroxyethoxy)-phenyl]-2-hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)-butane-1-one, diethoxyacetophenone, oligo {2-hydroxy-2-methyl-1-[4-(1-methylvinyl)phenyl]propanone}, and 2-hydroxy-1-{4-[4-(2-hydroxy-2-methylpropionyl)benzyl]phenyl}-2-methylpropane-1-one.

Examples of the benzophenone-based compound include benzophenone, 4-phenylbenzophenone, 2,4,6-trimethylbenzophenone, and 4-benzoyl-4′-methyldiphenyl sulfide. Examples of the α-ketoester-based compound include methyl benzoylformate, 2-(2-oxo-2-phenylacetoxyethoxy)ethyl ester of oxyphenyl acetic acid, and 2-(2-hydroxyethoxy)ethyl ester of oxyphenyl acetic acid.

Examples of the phosphine oxide-based compound include 2,4,6-trimethylbenzoyl diphenyl phosphine oxide, bis(2,4,6-trimethylbenzoyl)-phenylphosphine oxide, and bis(2,6-dimethoxybenzoyl)-2,4,4-trimethylpentyl phosphine oxide. Examples of the benzoin compound include benzoin, benzoin methyl ether, benzoin ethyl ether, benzoin isopropyl ether, and benzoin isobutyl ether. Examples of the acetophenone/benzophenone-hybrid-based photo initiator include 1-[4-(4-benzoylphenylsulfanyl)phenyl]-2-methyl-2-(4-methylphenylsulfinyl)propane-1-one. Examples of the oxime ester-based photo polymerization initiator include 2-(0-benzoyloxime)-1-[4-(phenylthio)]-1,2-octanedione.

As the component E, one kind of compound selected from these compounds may be used, or two or more kinds of compounds selected therefrom may be used in combination.

Component F: Colloidal Silica Having (Meth)Acryloyl Group

The film-forming component in the coating agent may contain, as an optional component, the component F including colloidal silica having a (meth)acryloyl group. By blending the component F in the coating agent, the curability of the coating agent can be improved, as well as the abrasion resistance and water resistance of the cured coating film can be further improved.

The component F is preferably colloidal silica having a (meth)acryloyl group and a hydrocarbon group. In this case, the weatherability and water resistance of the coating film can be further improved. From the viewpoint of further enhancing the above-described action and effect, the number of carbon atoms in the hydrocarbon group is preferably 3 or more and 13 or less, and more preferably 4 or more and 8 or less.

The content of the component F in the coating agent is, based on 100 parts by mass of the film-forming component, preferably set to be 1 part by mass or more, more preferably 3 parts by mass or more, and still more preferably 5 parts by mass or more. In this case, the abrasion resistance of the coating film can be further improved.

The content of the component F in the coating agent is, based on 100 parts by mass of the film-forming component, preferably set to be 30 parts by mass or less, more preferably 25 parts by mass or less, and still more preferably 20 parts by mass or less. In this case, while the effect of improving the curability and abrasion resistance by the component F is secured, the content of components other than the component F can be sufficiently increased, and the action and effect by these components can be enhanced in a well-balanced manner. As a result, weatherability, toughness, adhesion to the substrate, and abrasion resistance can be improved in a well-balanced manner.

As the component F, for example, surface-modified colloidal silica obtained by chemically modifying colloidal silica (f1) using a silane coupling agent (f2) having a (meth)acryloyl group; and surface-modified colloidal silica obtained by chemically modifying colloidal silica (f1) using a silane coupling agent (f2) having a (meth)acryloyl group and a silane coupling agent (f3) having a hydrocarbon group can be used.

The colloidal silica (f1) used for preparing the component F may have, for example, an alcoholic dispersion medium and silica primary particles dispersed in the alcoholic dispersion medium. The silica primary particles may exist in a state of being separated from each other in the alcoholic dispersion medium, or may exist as secondary particles formed by aggregation of a plurality of silica primary particles.

The average primary particle diameter of the silica primary particles is preferably 1 nm or more and 50 nm or less, and more preferably 1 nm or more and 30 nm or less. The abrasion resistance of the cured coating film can be further improved by setting the average primary particle diameter of the silica primary particles to 1 nm or more. The dispersion stability of colloidal silica can be further improved by setting the average primary particle diameter of the silica primary particles to 50 nm or less.

Note that the average primary particle diameter of the silica primary particles can be calculated on the basis of the specific surface area measured by the BET method. For example, when the average primary particle diameter of the silica primary particles is 1 nm or more and 50 nm or less, the specific surface area measured by the BET method is 30 m 2/g or more and 3000 m 2/g or less.

As the silane coupling agent (f2) having a (meth)acryloyl group to be reacted with the colloidal silica (f1), for example, 3-(meth)acryloyloxypropyltrimethoxysilane, 3-(meth)acryloyloxypropyltriethoxysilane, 2-(meth)acryloyloxyethyltrimethoxysilane, 2-(meth)acryloyloxyethyltriethoxysilane, 3-(meth)acryloyloxypropylmethyldimethoxysilane, 2-(meth)acryloyloxyethylmethyldimethoxysilane, vinyltrimethoxysilane, vinyltriethoxysilane, allyltrimethoxysilane, and allyltriethoxysilane can be used. These silane coupling agents (f2) may be used alone, or two or more may be used in combination.

As the silane coupling agent (f3) having a hydrocarbon group to be reacted with the colloidal silica (f1), for example, methyltrimethoxysilane, ethyltrimethoxysilane, propyltrimethoxysilane, isopropyltrimethoxysilane, butyltrimethoxysilane, cyclohexyltrimethoxysilane, hexyltrimethoxysilane, octyltrimethoxysilane, decyltrimethoxysilane, dodecyltrimethoxysilane, and phenyltrimethoxysilane can be used. The number of carbon atoms of the hydrocarbon group in the silane coupling agent (f3) is preferably 3 or more and 13 or less, and more preferably 4 or more and 8 or less. These silane coupling agents (f3) may be used alone, or two or more may be used in combination.

In synthesizing the component F, for example, a method of reacting the colloidal silica (f1) with the silane coupling agent (f2) in the presence of an organic solvent can be adopted. The addition amount of the silane coupling agent (f2) is, based on 100 parts by mass of the silica primary particles, preferably set to be 10 parts by mass or more and 40 parts by mass or less, and more preferably 10 parts by mass or more and 30 parts by mass or less.

For preparation of colloidal silica having a (meth)acryloyl group and a hydrocarbon group, a method of reacting the colloidal silica (f1) with the silane coupling agent (f2) and the silane coupling agent (f3) in the presence of an organic solvent can be adopted, for example. In this case, the addition amount of the silane coupling agent (f2) is, based on 100 parts by mass of the silica primary particles, preferably set to be 10 parts by mass or more and 40 parts by mass or less, and more preferably 10 parts by mass or more and 30 parts by mass or less. The addition amount of the silane coupling agent (f3) is, based on 100 parts by mass of the silica primary particles, preferably set to be more than 0 parts by mass and 30 parts by mass or less, and more preferably 5 parts by mass or more and 20 parts by mass or less.

Component G: Ultraviolet Absorber

The coating agent may contain, as an optional component, the component G including an ultraviolet absorber. The component G has an action of reducing deterioration of the coating film due to ultraviolet rays. The content of the component G may be set appropriately within the range of 1 part by mass or more and 12 parts by mass or less based on 100 parts by mass of the film-forming component. The weatherability of the cured coating film can be further improved by setting the content of the component G in the coating agent to 1 part by mass or more.

On the other hand, in the case where the content of the component G is excessively large, it may cause deterioration of the abrasion resistance of the coating film. Furthermore, the weatherability of the coating film may be rather deteriorated in this case. These problems can be avoided by setting the content of the component G to 12 parts by mass or less.

As the component G, for example, a triazine-based ultraviolet absorber, a benzotriazole-based ultraviolet absorber, a benzophenone-based ultraviolet absorber, a cyanoacrylate-based ultraviolet absorber, and inorganic fine particles that absorb ultraviolet rays can be used.

Examples of the triazine-based ultraviolet absorber include 2-[4-{(2-hydroxy-3-dodecyloxypropyl)oxy}-2-hydroxyphenyl]-4,6-bis(2,4-dimethylphenyl)-1,3,5-triazine, 2-[4-1(2-hydroxy-3-tridecyloxypropypoxyl-2-hydroxyphenyl]-4,6-bis(2,4-dimethylphenyl)-1,3,5-triazine, 2-[4-1(2-hydroxy-3-(2-ethylhexyloxy)propypoxyl-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, and 2-(2-hydroxy-4-[1-octyloxycarbonylethoxy]phenyl)-4,6-bis(4-phenylphenyl)-1,3,5-triazine.

Examples of the benzotriazole-based ultraviolet absorber include 2-(2H-benzotriazol-2-yl)-4,6-bis(1-methyl-1-phenylethyl)phenol, 2-(2-hydroxy-5-tert-butylphenyl)-2H-benzotriazole, and 2-[2-hydroxy-5-[2-(meth)acryloyloxyethyl]phenyl]-2H-benzotriazole.

As the benzophenone-based ultraviolet ray, for example, 2,4-dihydroxybenzophenone, and 2-hydroxy-4-methoxybenzophenone can be used. Examples of the cyanoacrylate-based ultraviolet absorber include ethyl-2-cyano-3,3-diphenylacrylate, and octyl-2-cyano-3,3-diphenylacrylate. Examples of the inorganic fine particles include titanium oxide fine particles, zinc oxide fine particles, and tin oxide fine particles.

As the component G, one kind selected from the above-mentioned compounds and inorganic fine particles may be used, or two or more kinds selected therefrom may be used in combination. As the component G, a benzotriazole-based ultraviolet absorber having a (meth)acryloyl group is preferably used. In this case, the weatherability and abrasion resistance of the coating film can be improved in a well-balanced manner.

Component H: Silicone-Based Surface Conditioner and Fluorine-Based Surface Conditioner

The coating agent may contain, as an optional component, a component H including one or more compounds of silicone-based surface conditioners and fluorine-based surface conditioners. The content of the component H may be set appropriately within the range of 0.01 parts by mass or more and 1 part by mass or less based on 100 parts by mass of the film-forming component. The abrasion resistance of the cured coating film can be further improved by setting the content of the component H in the coating agent to 0.01 parts by mass or more.

On the other hand, in the case where the content of the component H in the coating agent is excessively large, it may cause deterioration in appearance such as roughening of the surface of the cured coating film. Furthermore, when the content of the component H increases, material cost may increase as well. These problems can be avoided by setting the content of the component H to 1 part by mass or less.

As the component H, one, or two or more compounds selected from silicone-based surface conditioners and fluorine-based surface conditioners can be used.

As the silicone-based surface conditioner, for example, the following can be used: silicone-based polymers and silicone-based oligomers each having a silicone chain and a polyalkylene oxide chain; silicone-based polymers and silicone-based oligomers each having a silicone chain and a polyester chain; EBECRYL 350, and EBECRYL 1360 (manufactured by DAICEL-ALLNEX LTD.); BYK-315, BYK-349, BYK-375, BYK-378, BYK-371, BYK-UV 3500, and BYK-UV 3570 (manufactured by BYK JAPAN KK); X-22-164, X-22-164AS, X-22-164A, X-22-164B, X-22-164C, X-22-164E, X-22-174DX, X-22-2426, and X-22-2475 (manufactured by Shin-Etsu Chemical Co., Ltd.); AC-SQ TA-100, AC-SQ SI-20, MAC-SQ TM-100, MAC-SQ SI-20, and MAC-SQ HDM (manufactured by Toagosei Co., Ltd.); 8019 additive (manufactured by Dow Toray Co., Ltd.); polysiloxane; and dimethylpolysiloxane. Note that “EBECRYL” is a registered trademark of DAICEL-ALLNEX LTD., and “BYK” is a registered trademark of BYK JAPAN KK.

As the fluorine-based surface conditioner, for example, the following can be used: a fluorine-based polymer and a fluorine-based oligomer each having a perfluoroalkyl group and a polyalkylene oxide group; a fluorine-based polymer and a fluorine-based oligomer each having a perfluoroalkyl ether group and a polyalkylene oxide group; MEGAFACE RS-75, MEGAFACE RS-76-E, MEGAFACE RS-72-K, MEGAFACE RS-76-NS, and MEGAFACE RS-90 (manufactured by DIC Corporation); OPTOOL DAC-HP (manufactured by Daikin Industries, Ltd.); and ZX-058-A, ZX-201, ZX-202, ZX-212, and ZX-214-A (manufactured by T&K TOKA CO., LTD.). Note that “MEGAFACE” is a registered trademark of DIC Corporation, and “OPTOOL” is a registered trademark of Daikin Industries, Ltd.

Organic Solvent

The coating agent may contain an organic solvent for dissolving or dispersing each component described above. As the organic solvent, for example, the followings can be used: alcohols such as ethanol and isopropanol; alkylene glycol monoethers such as ethylene glycol monomethyl ether, propylene glycol monomethyl ether, propylene glycol monoethyl ether, propylene glycol monopropyl ether, and propylene glycol monobutyl ether; aromatic compounds such as toluene and xylene; esters such as propylene glycol monomethyl ether acetate, ethyl acetate, and butyl acetate; ketones such as acetone, methyl ethyl ketone, and methyl isobutyl ketone; ethers such as dibutyl ether; diacetone alcohol; and N-methyl pyrrolidone. The coating agent may contain one, or two or more of these organic solvents.

The coating agent preferably contains an alkylene glycol monoether as an organic solvent. Since the alkylene glycol monoether is excellent in dispersibility or solubility of each component described above, a uniform coated film can be formed after the coating agent is applied onto the substrate. When the substrate includes polycarbonate, a coated film can be formed without dissolving the substrate by using an alkylene glycol monoether as an organic solvent.

Other Additives

In addition to the components A to E as essential components, the coating agent may contain additives for the coating agent as long as curing of the coating agent is not inhibited. For example, the coating agent may contain an additive for reducing deterioration of the coating film, such as a radical scavenger and a hindered amine light stabilizer. The effect of improving the weatherability of the coating film can be expected by using these additives.

(Resin Glass)

The coating agent for resin glass is applied to the surface of the substrate including a transparent resin and is thereafter cured. This process makes it possible to obtain a resin glass that includes the substrate including a transparent resin and a coating film including a cured product of the coating agent for resin glass and covering the surface of the substrate. When the substrate has a plate shape, the coating film may be formed only on one surface or on both surfaces of the substrate. The film thickness of the coating film is not particularly limited, but can be appropriately set, for example, from a range of 1 μm or more and 50 μm or less. The film thickness of the coating film is preferably set to be 5 μm or more and 40 μm or less.

Since the cured product of the coating agent is transparent, resin glass lighter than inorganic glass can be obtained by forming the coating film on the surface of the substrate including a transparent resin. Further, since the coating film has high hardness, abrasion resistance of the resin glass can be improved. Furthermore, since the coating film is also excellent in toughness, the coating film easily follows the substrate in the case where the resin glass is thermally expanded, or the like, and the occurrence of a crack can be reduced.

The transparent resin constituting the substrate is not particularly limited, but for example, polycarbonate can be adopted. Polycarbonate is excellent in various properties required for a transparent member for a window, such as weatherability, strength, and transparency. Thus, a resin glass suitable as a transparent member for a window can be obtained by forming the coating film on the surface of a substrate including polycarbonate.

In preparing the resin glass, the following manufacturing method can be adopted, for example. The manufacturing method includes:
a preparation step of preparing a substrate;
an application step of applying the coating agent onto a surface of the substrate; and
a curing step of generating radicals from the component E in the coating agent to cure the coating agent on the surface of the substrate.

For application of the coating agent in the application step in the manufacturing method, an appropriate apparatus can be selected from known application apparatuses in accordance with a desired film thickness, a desired shape of the substrate, and the like, and then used. Examples of the application apparatus include a spray coater, a flow coater, a spin coater, a dip coater, a bar coater, and an applicator.

After the application step, a step of heating and drying the coating agent may be performed, as necessary.

In the curing step, radicals can be generated from the component E by irradiating the coating agent with light having an appropriate wavelength determined in accordance with the molecular structure of the component E.

After the curing step, a step of heating the coating film and facilitating curing may be performed, as necessary.

### EXAMPLES

Examples of the coating agent and the resin glass will be explained. Note that the aspect of the coating agent and the resin glass according to the present disclosure is not limited to the following aspects, and the configuration can be changed as appropriate within the spirit of the disclosure.

The coating agent of this example comprises a film-forming component including a component A consisting of a urethane (meth)acrylate having an isocyanuric ring skeleton, a component B consisting of a tri(meth)acrylate having an isocyanuric ring skeleton and having no urethane bond, a component C consisting of a multi-functional (meth)acrylate having a (meth)acrylic equivalent of 80 to 200, and a component D consisting of a urethane (meth)acrylate that has a polycarbonate skeleton, two to four polymerizable unsaturated groups per molecule, and a weight average molecular weight of 10,000 or less, and a component E consisting of a photoradical polymerization initiator.

The content of the component E is set to 0.1 parts by mass or more and 10 parts by mass or less based on 100 parts by mass of the total film-forming component.

The compounds used for preparing the coating agent in this example are specified as follows.

Component A
A-1: Addition product of a nurate trimer of hexamethylene diisocyanate and hydroxyalkyl (meth)acrylate

Component B
B-1: M-315 (manufactured by Toagosei Co., Ltd., mixture containing isocyanuric acid ethylene oxide-modified triacrylate)

Component C
C-1: Dipentaerythritol hexaacrylate (“A-DPH” manufactured by SHIN-NAKAMURA CHEMICAL Co., Ltd., (meth)acrylic equivalent: 96)

Component D
D-1: UN-9000PEP (manufactured by Negami Chemical Industrial Co., Ltd., urethane acrylate having a polycarbonate skeleton and two polymerizable unsaturated groups per molecule and having a weight average molecular weight of 5,000)

Component E
E-1: Omnirad 754 (manufactured by IGM Resins B.V., phosphine oxide-based photoradical polymerization initiator)
E-2: Omnirad 819 (manufactured by IGM Resins B.V., photoradical polymerization initiator containing α-ketoester-based compound)

Component F
F-1: Surfaced-modified colloidal silica having (meth)acryloyl group and hydrocarbon group

Note that “Omnirad” is a registered trademark of IGM Group B.V.

Table 1 provides examples of compositions of coating agents prepared using these compounds (test agents 1 to 5). Preparation of the test agents 1 to 5 only requires that each component be dissolved or dispersed in an organic solvent at a mass ratio shown in Table 1, as well as that 0.1 parts by mass or more and 10 parts by mass or less of the component E be blended based on 100 parts by mass of the film-forming component, that is, a total of the components A to D and the component F. Note that the test agent 6 listed in Table 1 is a test agent for comparison with the test agents 1 to 5. The preparation method of the test agent 6 is the same as the preparation methods of the test agents 1 to 5 except that the mass ratio of each component is changed as shown in Table 1.

Although not shown in Table 1, the test agents 1 to 6 each contain 1 part by mass or more and 12 parts by mass or less of the ultraviolet absorber (component G) based on 100 parts by mass of the total film-forming component, and 0.01 parts by mass or more and 1.0 parts by mass or less of the surface conditioner (component H) based on 100 parts by mass of the total film-forming components. The ultraviolet absorber used in this example is specified as RUVA 93 (manufactured by Otsuka Chemical Co., Ltd.) and Tinuvin 479 (manufactured by BASF, hydroxyphenyltriazine-based ultraviolet absorber). The surface conditioner used in this example is specified as 8019 additive (manufactured by Dow Toray Co., Ltd., silicone-based surface conditioner). Note that “Tinuvin” is a registered trademark of BASF.

Next, an example of a method for producing a resin glass using a coating agent will be explained. First, a substrate onto which the coating agent is applied is prepared. The substrate used in this example is a plate material including polycarbonate and having a plate thickness of 5 mm.

After the coating agent is applied onto one surface of the substrate using a flow coater, the substrate is heated at a temperature of 100° C. for 10 minutes to dry the coating agent. Thereafter, radicals are generated from the component E in the coating agent, so that the coating agent can be cured to form a coating film. In the test agents 1 to 6 listed in Table 1, for example, the test agents may be irradiated with ultraviolet light generated from a high-pressure mercury lamp having a peak illuminance of 300 mW/cm².

As described above, a coating film including a cured product of the test agent can be formed on one surface of the substrate to obtain resin glass.

The weatherability of the coating film can be evaluated by the following method.

Weatherability

The weatherability of the coating film can be evaluated on the basis of the presence or absence of the occurrence of a crack after the accelerated weathering test has been performed. In the accelerated weathering test, the coating film is irradiated with light generated from xenon arc lamp using a xenon arc weathering instrument. Then, after 2000 hours have elapsed from the start of irradiation, the coating film is visually observed to evaluate whether or not a crack has occurred.

In the column of “Weatherability” in Table 1, a case where no crack occurred in the coating film after 2000 hours had elapsed is denoted by “Good”, and a case where a crack occurred is denoted as “Poor”. In the evaluation of the weatherability, when no crack occurred in the coating film after 2000 hours had elapsed, the coating film was determined to have excellent weatherability and to be acceptable. On the other hand, when a crack occurred, the coating film was determined to be poor in weatherability and to be unacceptable.

TABLE 1

| | | | Test | Test | Test | Test | Test | Test |
|---|---|---|---|---|---|---|---|---|
| | | | Agent 1 | Agent 2 | Agent 3 | Agent 4 | Agent 5 | Agent 6 |
| Component A | A-1 | Parts by Mass | 30 | 30 | 25 | 20 | 25 | 25 |
| Component B | B-1 | Parts by Mass | 35 | 40 | 40 | 40 | 40 | 40 |
| Component C | C-1 | Parts by Mass | 20 | 20 | 20 | 20 | 22.5 | 25 |
| Component D | D-1 | Parts by Mass | 5 | 5 | 5 | 10 | 2.5 | — |
| Component F | F-1 | Parts by Mass | 10 | 5 | 10 | 10 | 10 | 10 |

| | | | | | | | |
|---|---|---|---|---|---|---|---|
| Weatherability | — | Good | Good | Good | Good | Good | Poor |

As shown in Table 1, the test agents 1 to 5 each contain all the components A to E described above. Therefore, the coating film including these test agents has excellent weatherability.

On the other hand, in the test agent 6 not containing the component D, a crack occurred in the coating film by light irradiation for 2000 hours, and thus, the test agent 6 is inferior in weatherability to the test agents 1 to 5 containing the component D.

As can be understood from the above results, by blending the component D in the film-forming component, a coating film having excellent weatherability can be formed.

1. A coating agent for resin glass, the coating agent comprising:
a film-forming component including
a component A consisting of a urethane (meth)acrylate having an isocyanuric ring skeleton,
a component B consisting of a tri(meth)acrylate having an isocyanuric ring skeleton and having no urethane bond,
a component C consisting of a multi-functional (meth)acrylate having a (meth)acrylic equivalent of 80 to 200, and
a component D consisting of a urethane (meth)acrylate that has
a polycarbonate skeleton,
two to four polymerizable unsaturated groups per molecule, and
a weight average molecular weight of 10,000 or less; and
a component E consisting of a photoradical polymerization initiator,
wherein a content of the component E is 0.1 parts by mass or more and 10 parts by mass or less based on 100 parts by mass of the total film-forming component.

2. The coating agent for resin glass according to claim 1, wherein, based on 100 parts by mass of the total film-forming component, a content of the component A is 3 parts by mass or more and 60 parts by mass or less, a content of the component B is 10 parts by mass or more and 50 parts by mass or less, a content of the component C is 5 parts by mass or more and 50 parts by mass or less, and a content of the component D is 1 part by mass or more and 30 parts by mass or less.

3. The coating agent for resin glass according to claim 1, wherein the film-forming component further includes a component F consisting of colloidal silica having a (meth)acryloyl group.

4. The coating agent for resin glass according to claim 3, wherein a content of the component F is 1 part by mass or more and 30 parts by mass or less based on 100 parts by mass of the total film-forming component.

5. The coating agent for resin glass according to claim 1, further comprising:
a component G consisting of an ultraviolet absorber,
wherein a content of the component G is 1 part by mass or more and 12 parts by mass or less based on 100 parts by mass of the total film-forming component.

6. The coating agent for resin glass according to claim 1, further comprising:
a component H consisting of one or more compounds selected from silicone-based surface conditioners and fluorine-based surface conditioners,
wherein a content of the component H is 0.01 parts by mass or more and 1.0 parts by mass or less based on 100 parts by mass of the total film-forming component.

7. Resin glass comprising:
a substrate including a transparent resin; and
a coating film including a cured product of the coating agent for resin glass according to claim 1 and covering a surface of the substrate.

8. The resin glass according to claim 7, wherein the substrate includes polycarbonate as the transparent resin.
